(19) United States
(12) Patent Application Publication
(10) Pub. No.: US 2008/0210761 A1
(43) Pub. Date: Sep. 4, 2008

(54) Token Coin and Manufacturing Method Thereof

(76) Inventor: Ran Sook Jeon, Boochun-shi Kyunggi-Do (KR)

Correspondence Address: IPLA P.A., 3580 WILSHIRE BLVD., 17TH FLOOR, LOS ANGELES, CA, 90010, US

(21) Appl. No.: 10/597,167

(22) PCT Filed: Jan. 13, 2005
(86) PCT No.: PCT/KR2005/000106

§ 371 Date: Jul. 13, 2006

(30) Foreign Application Priority Data
Jan. 14, 2004 (KR) 10-2004-0002506

(51) Int. Cl. B29C 45/00; G06K 19/067

(52) U.S. Cl. 235/492; 264/238

(57) ABSTRACT

A token coin and a manufacturing method thereof are disclosed. The token coin with an RF label embedded therein may be used as a disposable coin or a fixed amount coin. Although the token coin is manufactured through insert-injection molding with the RF label embedded therein, the RF label is not damaged by the high temperature of the molding process. The token coin includes a coin body (10) fabricated from first and second discs (12, 14) each having a depression (16) at a central portion thereof. The RF label (20) is disposed in the depressions (16) of the coin body (10). The coin body (10) having the RF label (20) is, thereafter, inserted in an insert-injection mold and is subjected to an insert-injection molding process so that an outer ring 30 is integrally formed around the circumferential edge of the coin body (10), thus providing a token coin.

### BRIEF DESCRIPTION OF DRAWINGS

FIG. 1 is a front view of a token coin according to a first embodiment of the present invention.

FIG. 2 is a rear view of the token coin.

FIG. 3 is a cross sectional view, taken along line A-A of FIG. 1.

FIG. 4a is a view showing a coin for use as a passenger ticket, in accordance with a second embodiment of the present invention.

FIG. 4b is a view showing a coin for use as a passenger ticket, in accordance with a third embodiment of the present invention.

FIG. 5 is a flow chart illustrating the production of the coin according to the present invention.

### DESCRIPTION OF NUMERALS FOR MAIN PARTS OF DRAWINGS

10: body
12: first disc
14: second disc
20: RF label
30: outer ring
40: decal

### DETAILED DESCRIPTION OF THE INVENTION

### Object of the Invention

### Technical Field and Background Art

The present invention relates to a disposable or fixed amount token coin (hereinafter referred generally to as “coin”) for use as a passenger ticket for a subway or bus. More particularly, the present invention relates to a coin with an RF label embedded therein, which is not readily damaged even after the coin is repetitively reused, and in which the RF label is protected from the high temperature and pressure of an injection molding process for forming a guard around the circumference of the coin.

Conventionally, credit cards or coins have magnetic tapes or bar codes attached thereon as recognition tags. However, these conventional recognition tags' suffer from disadvantages. Magnetic tapes are not durable because they are readily worn out upon frequent contact with readers therefor. Usually, once information is input, magnetic tapes attached to cards or tokens cannot be reused by revising the information. Bar codes, even though operated in a non-contact manner, are recognized only at a short distance, are impossible to reuse, and are not secure.

Recently, RF labels taking advantage of microchips (also called IC chips) have found application in a variety of fields, including commercial transactions. For example, RF labels are widely used as payment means for bus, electric railway or subway fares. These microchips can be used for a long period of time due to their non-contact operation manner and can be recognized at a long distance (up to 5 m) in addition to being reusable with the revision of information.

However, microchip-attached RF labels (hereinafter referred to as just “RF labels”) must be carefully treated because they are as thin as paper and vulnerable to heat or impact.

Korean Pat. No. 10-024967 discloses a coin-type IC card with a micrcochip included therein, which is provided for a passenger ticket. This coin-type IC card comprises two laminated discs with an RF label sandwiched therebetween, and a printed sheet, such as cellophane, which covers the front and rear surface of the laminate. After having been used, the coin-type IC card can be recovered from a card reader and repetitively reused by passengers who purchased it.

However, the coin-type IC card, which is of a simple structure laminated with two discs, an RF label, and a cellophane sheet, does not show good durability. If the IC card is moved many times within card readers to read the information, its lateral surfaces continually contact parts of the readers and the laminated layers peel off.

Being as thin as paper and vulnerable to heat, the RF label embedded in the IC cards cannot endure the heat and pressure of injection molding. Instead of insert injection molding, heat fusion, ultrasonic fusion or adhesive bonding is used to fix an RF label between two plastic sheets.

However, such a card is found to be susceptible to impact, moisture, heat, etc. In the presence of these factors, the plastic sheets easily separate, or the printed film readily peels off or is damaged. Particularly, a recoverable coin, whether disposable or of a fixed amount, is repetitively used not by a particular person but by multiple anonymous people, so that it is readily damaged.

Korean Pat. Application No. 2003-15925, filed by the present inventors, discloses a reusable coin for use as a disposable passenger ticket and a manufacturing method thereof.

Because the description is limited to a disposable token, the coin of the above patent application may be misunderstood as not being applicable to fixed amount tokens. In addition, the coin is not provided with a means for holding the coin, so that it may be readily lost or inconvenient to use.

### Technical Subjects to be Accomplished

An object of the present invention is to provide a coin usable as a passenger ticket (including disposable and fixed amount tickets) having enhanced durability, which does not peel at its laminated layer or circumferential edge even after it is repetitively reused.

Another object of the present invention is to provide a method of manufacturing a durable coin at low cost, by completely coating an impact-resistant polycarbonate or nylon resin around the circumferential edge of an RF label-embedded plastic body consisting of two discs so as to protect the RF label from damage and the discs from peeling off.

A further object of the present invention is to provide a coin with characters or symbols printed thereon, which requires no additional printing process every time it is recovered.

### CONSTITUTION OF THE INVENTION

In order to accomplish the above objects, the present invention provides a token coin, comprising: a body fabricated by combining a first disc with a second disc, the first disc having a depression at a central portion thereof, the second disc having a depression corresponding to that of the first disc; a circular RF label disposed in the depression; and an outer ring formed around the circumferential edge of the body through an injection molding process after inserting the body into an injection mold.

The body is made from polycarbonate or nylon.

In the token coin, the outer ring is made from polycarbonate or nylon.

In the token coin the body has an advertisement decal on each outer side.

Also, the token coin has a perforated hole at a circumferential edge portion, the hole providing a means through which a holder are connected to the coin.

The holder is selected from among a key holder, a mobile phone holder, and a string.

Also, provided is a method of manufacturing a token coin, comprising: a body preparation step in which a first disc and a second disc is injection molded, each having a depression on the inner side; an RF label insertion and body combination step in which an RF label is disposed and the first disc is combined with the second disc to form a body, with the depressions facing each other; and an outer ring formation step in which the body is inserted into an injection mold and polycarbonate or nylon is injection molded into an outer ring around the circumferential edge of the body.

In the method, an RF label bonding step in which the RF label is bonded to the first disc and the second disc in the depression may be further comprised between the RF label insertion and body combination step and the outer ring formation step.

The method may also further comprise a decal attachment step in which a decal is attached to either outer side of the body, after the outer ring formation step.

The method may also further comprise a hole perforation step in which the coin is perforated to form a hole through which a holder can be provided to the coin.

Reference should now be made to the drawings, in which the same reference numerals are used throughout the different drawings to designate the same or similar components.

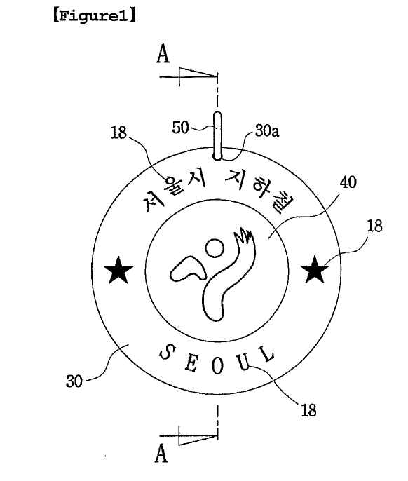

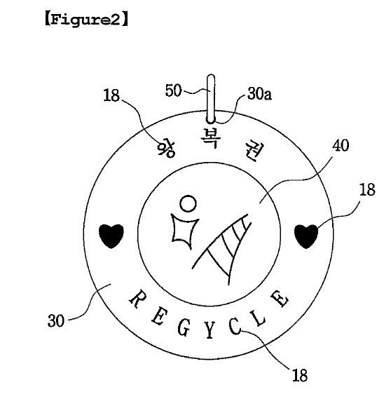

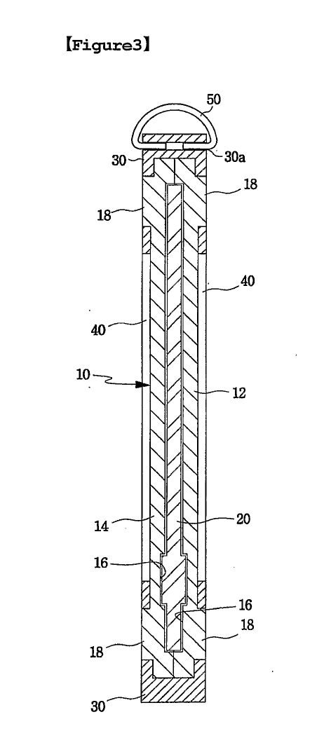

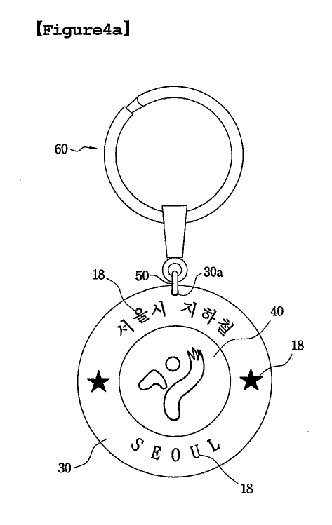

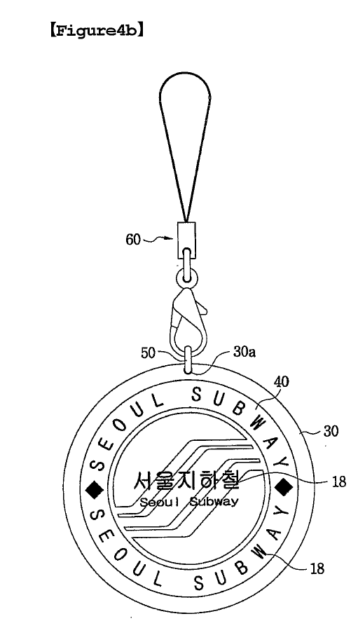

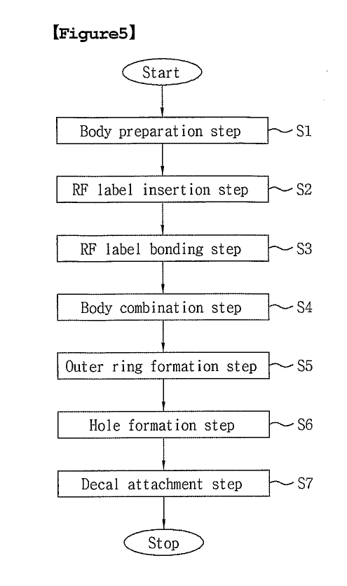

FIG. 1 is a front view of a coin for use as a passenger ticket, in accordance with a first embodiment of the present invention. FIG. 2 is a rear view of the coin of FIG. 1. FIG. 3 is a cross sectional view, taken along line A-A of FIG. 1. FIG. 4a is a view showing a coin for use as a passenger ticket, in accordance with a second embodiment of the present invention. FIG. 4b is a view showing a coin for use as a passenger ticket, in accordance with a third embodiment of the present invention. FIG. 5 is a flow chart illustrating the production of the coin according to the present invention.

As shown in FIGS. 1 to 3, the coin for a passenger ticket comprises a body 10 which determines the general figure of the coin, an RF label 20 inserted into the body 10, and an outer ring 30 coated on the circumferential edge of the body 10.

The body 10 consists of two discs bonded with each other: a first disc 12 having a depression 16 at a central portion on its inner side, and a second disc 14 having a depression 16 corresponding to the counterpart of the first disc 12. The first disc 12 is identical in size and shape to the second disc 14. On the inner side of the first disc 12 is formed a depression 16 which has the mirror image of that formed on the inner side of the second disc 14. The first disc 12 is laid on the second disc 14 so that the depressions 16 formed on the inner sides of the plates perfectly align with each other.

When the depressions combine symmetrically with each other, a space is formed for receiving the RF label 20.

The first disc 12 and the second disc 14 may be made from synthetic resins or non-metallic materials, such as ceramic, glass, stone, etc. Preferable is nylon or polycarbonate.

On the outer sides of both the first and the second discs 12 and 14, characters or symbols are preferably carved in relief or engraved so as to eliminate printing thereon every time the coin is recovered.

It is also preferred that the outer ring 30 be layered as deeply as possible on the first disc 12 and the second disc 14.

The RF label 20 is accommodated in the inner sides of the first disc 12 and the second discs 14. The RF label 20 is a kind of electronic magnetic label and is composed of a circular film with a microchip embedded therein. The RF label 20 may be fixed in the receiving depression 16 formed in the first and the second discs 12 and 14 and the fixation may be performed with the aid of an adhesive such as two-sided tape or glue. According to a preset program, information is input into the RF label 20 so as to use the coin as a disposable or fixed-amount passenger ticket.

Along the circumferential edge of the body in which the RF label 20 is embedded, the outer ring 30 made from polycarbonate or nylon is coated. A decal 40 may be attached onto each of the outer sides of the body 10. Use of the same material as the first disc 12 and the second disc 14 enhances the bonding between the outer ring 30 and the first and the second discs 12 and 14.

At a predetermined portion of the coin, a hole 30a is formed. In greater detail, the outer ring 30 is perforated at a predetermined portion (near the edge) to form a hole 30a. Through the hole 30a, a desired holder 60 or a string (not shown) can be provided to the body. The holder 60 is not limited to particular ones, but may be in a wide variety of forms. For example, a key holder 60 (FIG. 4a), a mobile phone holder (FIG. 4b), or a spring cord may be used as the holder 60 connected with a hook ring 50 which is directly provided to the hole 30a.

Through the holder 60, the user can hang the coin. Alternatively, a mechanical spring-driven measuring tape, instead of the holder, may be provided for the coin.

In accordance with a third embodiment shown in FIG. 4b, the decal is attached onto the central portion of the coin, with no advertisement copy formed on the circumferential edge of the coin.

Below, a detailed description will be given of the production process of the coin, with reference to FIGS. 1 to 5.

First, polycarbonate or nylon is injection molded into the first disc 12 and the second disc 14, both constituting the body 10, each of which has an engraved portion on the outer side and a depression on the inner side. (Body preparation step) (S1)

Afterwards, the RF label 20 is inserted in the receiving depression 16 formed on the first disc 12 or the second disc 14. (RF label insertion step) (S2)

Following the RF label insertion step (S2), the RF label is fixed onto the receiving depression 16 by use of an adhesive or two-sided tape. Otherwise, the RF label 20 may move within the receiving depression of the first disc 12 and the second disc 14, making noise. (RF label bonding step) (S3)

Subsequent to the RF label bonding step (S3), the first disc 12 is combined with the second disc 14 to form the body 10 in which the inner side of the first disc 12 faces that of the second disc 14. (Body combination step) (S4).

Next to the body combination step (S4), the body is inserted into an injection mold for coins (including disposable and fixed amount types) and then, polycarbonate or nylon is subjected into injection molding to form the outer ring 30 along the circumference of the body 10. At this time, the engraved portion 18 on the outer side of the body is not covered with the outer ring 30 but is externally visible, thus requiring no additional printing of characters or symbols. (Outer ring formation step) (S5)

After the outer ring formation step (S5), the outer ring 30 is perforated to form the hole 30a through which the holder 60 is connected via a hook ring 50. (Hole perforation step) (S6).

Finally, an advertisement decal 40 is attached to each of the outer sides of the body 10. (Decal attachment step) (S7)

Generically, the RF label insertion step (S2) and the body combination step (S4) may be called an RF label insertion and body combination step. As a result, a coin for use as a passenger ticket, which is excellent in durability in addition to being light, can be produced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### EFFECT OF THE INVENTION

In accordance with the present invention, because the outer ring is formed around the circumferential edge of the body, the circumferential portion of the coin does not peel off even if the coin, usable as a disposable or fixed-amount passenger ticket, is repeatedly used, resulting in a great increase in the durability of the coin.

Being embedded in the plastic body, the RF label is not damaged when the outer ring is injection molded at the circumference of the body.

In addition, the user can fix the coin to the body or hang the coin around the neck by use of an additional member, such as a string or a ring, which is linked to the body through the hole formed at a predetermined position in the coin, thereby preventing the loss of the coin as well as increasing the convenience of use.

1. A token coin, comprising:
a body fabricated by combining a first disc with a second disc, the first disc having a depression at a central portion thereof, the second disc having a depression corresponding to that of the first disc;
a circular RF label disposed in the depression; and
an outer ring formed around the circumferential edge of the body through an injection molding process after inserting the body into an injection mold.

2. The token coin according to claim 1, wherein the body is made from polycarbonate or nylon.

3. The token coin according to claim 1, wherein the outer ring is made from polycarbonate or nylon.

4. The token coin according to claim 1, wherein the body has an advertisement decal on each outer side.

5. The token coin according to claim 1, wherein the token coin has a perforated hole at a circumferential edge portion, the hole providing a means through which a holder is connected to the coin.

6. The token coin according to claim 1, wherein the holder is selected from among a key holder, a mobile phone holder, and a string.

7. A method of manufacturing a token coin, comprising:
a body preparation step in which a first disc and a second disc are injection molded, each having a depression on the inner side;
an RF label insertion and body combination step in which an RF label is disposed and the first disc is combined with the second disc to form a body, with the depressions facing each other; and
an outer ring formation step in which the body is inserted into an injection mold and polycarbonate or nylon is injection molded into an outer ring around the circumferential edge of the body.

8. The method according to claim 7, further comprising an RF label bonding step in which the RF label is bonded to the first disc and the second disc in the depression, between the RF label insertion and body combination step and the outer ring formation step.

9. The method according to claim 8, further comprising a decal attachment step in which a decal is attached to either outer side of the body, after the outer ring formation step.

10. The method according to claim 8, further comprising a hole perforation step in which the coin is perforated to form a hole through which a holder can provided to the coin.
